(19) United States
(12) Patent Application Publication
(10) Pub. No.: US 2014/0081740 A1
(43) Pub. Date: Mar. 20, 2014

(54) METADATA-BASED CROSS-CHANNEL MARKETING ANALYTICS

(71) Applicant: MARKETO, INC, San Mateo, CA (US)

(72) Inventors: Glen Lipka, San Mateo, CA (US); Yan Zou, Mountain View, CA (US); Sarah Yi Tsang, San Carlos, CA (US); Simon Shyh-Kaai Lee, Cupertino, CA (US)

(73) Assignee: MARKETO, INC., San Mateo, CA (US)

(21) Appl. No.: 13/621,675

(22) Filed: Sep. 17, 2012

(51) Int. Cl. G06Q 30/02

(52) U.S. Cl. 705/14.42; 705/14.4

(57) ABSTRACT

A marketing management system interfaces with a sales platform, company servers, and various other sources of data to obtain information about leads, programs in various channels, interactions, and opportunities. The system provides a user interface that enables users to define metadata tags for marketing programs to indicate various common aspects of the programs, such as program success criteria, parent program, acquisition program for a lead, and the like. This metadata-based tag system allows for comparison of marketing programs in different channels, facilitating cross-channel analytics otherwise unavailable to users of the marketing management system. One type of cross-channel analytics includes the accurate attribution of marketing contributions to revenue generation and lead acquisition.

### BACKGROUND

This invention relates generally to marketing systems, and in particular to metadata-based cross-channel marketing analytics.

In recent years, sales and marketing departments have migrated to automated marketing/sales platforms to track entities such as leads, opportunities, and accounts, as well as interactions that are associated with these entities. A lead is a person, sometimes representing a company, who may have interests in a firm's products or services. A marketing department receives new leads (names) through website visits, or marketing campaigns such as pay per click (PPC), tradeshows, and road shows, etc. After a lead is received by the marketing department, it is nurtured so that it may develop into an opportunity—people or companies with genuine buying intent in the near future. Actions taken to nurture and develop the lead include various programs, or marketing activities, in various channels, or types of marketing activities, such as marketing emails, phone calls, invitations to webinars, white papers, road shows, and so forth. Once marketing decides that there is a potential for the lead to buy the firm's products or services in the near future, the lead is sent to the sales department, where the lead is followed up to determine whether there is a genuine intent to purchase. An opportunity is created, mostly by sales, when such intent exists. Sales representatives will then work on the opportunity and try to close the deal. An account usually refers to a company, which could have multiple leads that are captured by the firm's marketing system. An account could also have many sales opportunities, including an initial sales opportunity, an upsell/cross-selling opportunity, and the like.

Interactions associated with the lead entities include aforementioned marketing actions, as well as actions taken by sales staff—i.e., sales emails, phone calls, online meeting, demos, customer visits, to name just a few. They also include activities such as web visits, which are originated by the leads, both before and after the leads reach the opportunity status. Because a lead is frequently attached to accounts, especially in enterprise sales, interactions are likely associated with accounts. Similarly, interactions may also be associated with opportunities.

Marketing departments run hundreds or thousands of marketing programs—email campaigns, pay-per-click (PPC), trade shows, webinars, blogs, etc.—for lead generation and nurturing each year. Such programs belong to different channels and can be drastically different from each other. For each channel, different analytics may be measured. Email performance analytics may display a number of emails sent, opened, clicked, or bounced for individual email campaigns. Webinar attendance analytics may display a number of people that received invitations, signed up for the webinar, attended the webinar, and downloaded the white paper afterwards. Comparing programs in the same channel becomes relatively straightforward because the same analytics are used for different programs in the same channel. However, cross-channel analytics, or comparing programs in different channels, is more complex based on the different characteristics of the channels.

Existing marketing/sales systems do not effectively provide cross-channel analytics to their users. Existing systems may provide limited cross-channel analytics that attempt to find commonalities among programs and provide analytics based on those commonalities. However, finding commonalities among hundreds or thousands of programs to compare the efficacy of those programs is not easily formulated nor answered accurately as such commonalities rarely exist by default. In business-to-business (10B) marketing, an individual sales opportunity may take months to develop, often involving different programs to influence a lead to create and close the opportunity, such as email campaigns, webinars, trade shows, and the like. Attributing a success, such as the creation and closing of a sales opportunity, or an acquisition, such as identifying a first effective touch of a marketing program that generated the lead that eventually matured into an opportunity, to one or more of the different programs that the lead may be associated with is challenging and complex when analyzing programs in different channels. However, this information would be valuable to a marketing executives looking to show a return on investment on the marketing budget on these programs in terms of tangible sales data. Without this information, marketing departments may not be able to identify high-performing marketing programs compared to other marketing programs, having to justify marketing spend based on a simple aggregated marketing budget and aggregated sales.

Specifically, marketing/sales departments do not have an effective tool to analyze cross-channel marketing programs to provide meaningful metrics with regards to a large set of business questions of an analytics nature, including success and acquisition attribution. An efficient mechanism is needed to compare otherwise unrelated marketing programs and measure the effectiveness of marketing programs in different channels on producing sales revenue. As a result, marketing spend may be allocated more efficiently through highly targeted marketing campaigns, generating additional sales revenue. Existing analytics systems have not provided users with tools or methods of providing analytics on the abundance of channel activity information with respect to programs and opportunities.

### SUMMARY

A marketing management system interfaces with a sales platform, company servers, and various other sources of data to obtain information about leads, programs in various channels, interactions, and opportunities. The system provides a user interface that enables users to define metadata tags for marketing programs to indicate various common aspects of the programs, such as program success criteria, parent program, acquisition program for a lead, and the like. This metadata-based tag system allows for comparison of marketing programs in different channels, facilitating cross-channel analytics otherwise unavailable to users of the marketing management system. One type of cross-channel analytics includes the accurate attribution of marketing contributions to revenue generation and lead acquisition.

### BRIEF DESCRIPTION OF THE DRAWINGS

FIG. 1A is high level block diagram illustrating cross-channel analytics in a marketing management system, in accordance with an embodiment of the invention.

FIG. 1B is high level block diagram illustrating a process of providing cross-channel analytics in a marketing management system, in accordance with an embodiment of the invention.

FIG. 2 is a network diagram of a system for providing cross-channel analytics in a marketing management system, showing a block diagram of the marketing management system, in accordance with an embodiment of the invention.

FIG. 3 is high level block diagram illustrating a marketing analytics manager that includes various modules for providing cross-channel analytics to users of a marketing management system, in accordance with an embodiment of the invention.

FIG. 4 is a flowchart of a process of providing cross-channel analytics in a marketing management system, in accordance with an embodiment of the invention.

FIGS. 5A-E include example screenshots of charts and a graph illustrating cross-channel analytics in a marketing management system, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

A marketing management system provides its users with the ability to collect and organize information about marketing activity conducted to produce sales opportunities. Included in this information are program tags and program successes. A mechanism, methods, and/or a system may be provided for marketers to define metadata for each marketing program in a marketing management system. Cross-channel metadata may be defined in order to serve as the “commonalities” among programs in the different channels, thus enabling cross-channel marketing analytics.

As an example, different marketing programs have different success criteria. A campaign email generates no impact until it is clicked. A webinar session is successful with respect to a particular lead only if the lead attends the webinar. By defining a metadata tag called “program success”, different programs have customized success criteria and may subsequently be compared based on program success. As a second cross-channel example, a marketing department attending a Vegas show may run multiple programs: it has a booth, its executives may give several talks, it may sponsor or co-sponsor certain events/parties, etc. Before the show, campaign emails may be sent encouraging prospects to attend the show; after the show, marketers may send follow-up email/webinar invitations. All these programs are related to the Vegas show and are cross-channel. By defining a metadata tag “parent program,” whose name for the example mentioned here is “Vegas show,” the programs can be filtered based on parent program, and the impact of these programs can be compared and aggregated.

A program tag may include any metadata that is attached to marketing activity, such as a name of a program, a cost of a program, and so forth. A program success may be defined as a particular program tag that may be defined specifically for a program channel based on various criteria. For example, program successes for an email campaign may be defined as the recipient opening the email, clicking on a link inside the email, and/or completing a form on a website redirected by the link. Frequently, such a system receives this information from a variety of sources, including a sales platform, a company's systems, and other data sources. In a marketing management system, an opportunity may be defined as a record in a database system indicating a point in time when a sales representative may start to interact with a potential customer. Marketers may conduct numerous activities in various program channels to generate leads—people that could become opportunities—for sales representatives to contact and close sales opportunities. Activities in program channels may include producing whitepapers, distributing online web content, attending trade shows, conducting webinars to demonstrate a product, and following up with prospective customers. Historically, marketers have generated metrics that only answer intra-channel questions, such as “how many emails have been clicked on?” or “how many people attended a webinar?” Metadata, such as “program success” may be attached to the activities in program channels to indicate whether a program has reached “success” based on different criteria specific to each program channel. Once leads have been generated and nurtured into potential sales opportunities, meaning that customers' needs have been identified, sales representatives follow up to verify whether there is a genuine buying intent. If such intent exists, a sales opportunity is created and sales representatives will then try to close the opportunities. Each opportunity may eventually be closed by a sales representative as “won” or “lost,” meaning that a sales transaction was or was not successful. Marketers may then attribute creation and closing of opportunities to the program successes of the marketing activities across the different program channels.

The marketing management system may gather interactions with leads performed by marketing staff and sales representatives from an external sales platform, a company's systems, and other data sources, such as spreadsheets, databases, and other records that have been created over time. Program tags such as program successes, attached as metadata for the gathered interactions with leads, organized by account and by opportunity, may be analyzed in charts and/or plotted along a timeline by the marketing management system. As a result, marketing staff may analyze the impact of marketing activities on the revenue cycle at the opportunity level across program channels using program successes and other program tags. Various cross-channel analytics may be defined and generated using customizable program tags, including program attribution conditioned on program successes, an average number of program successes required before creating an opportunity, number of program successes by territory/geographic location, and so forth.

Program tags enable marketing departments to generate numerous cross-channel analytics on marketing programs produced for various events, such as product campaigns, conferences, and so forth. For example, a marketing department may attend a conference to promote a product, setting up a booth at the conference, giving five different talks at the conference, running an online pay-per-click (PPC) advertising campaign based on the event, and sponsoring a party at night. This major event involves eight different programs across multiple channels. Without program tags, the programs as entered into a marketing management system are unrelated. However, using program tags, metadata may be attached to each program across the multiple channels. Various cross-channel analytics may be generated to answer cross-channel questions, such as “how many leads did the event generate?,” “how many opportunities did the event generate?,” “how many leads cumulatively convert to opportunities after each program?,” “how many people achieved success for each program/channel?,” and the like.

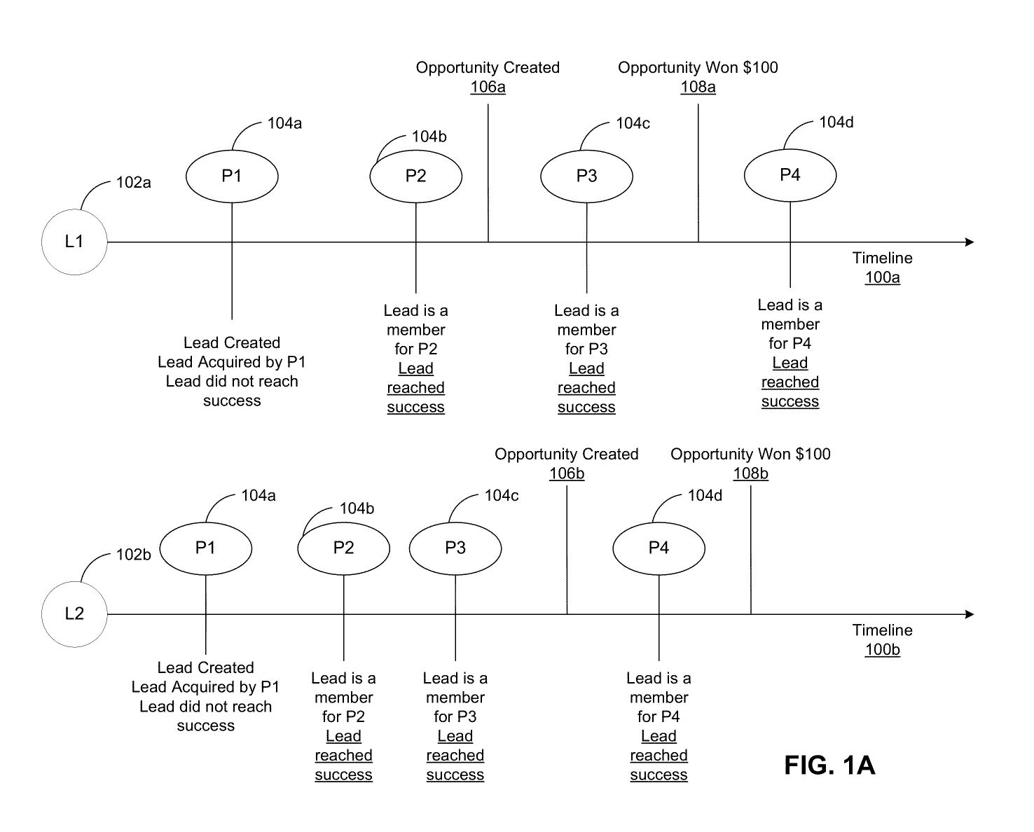

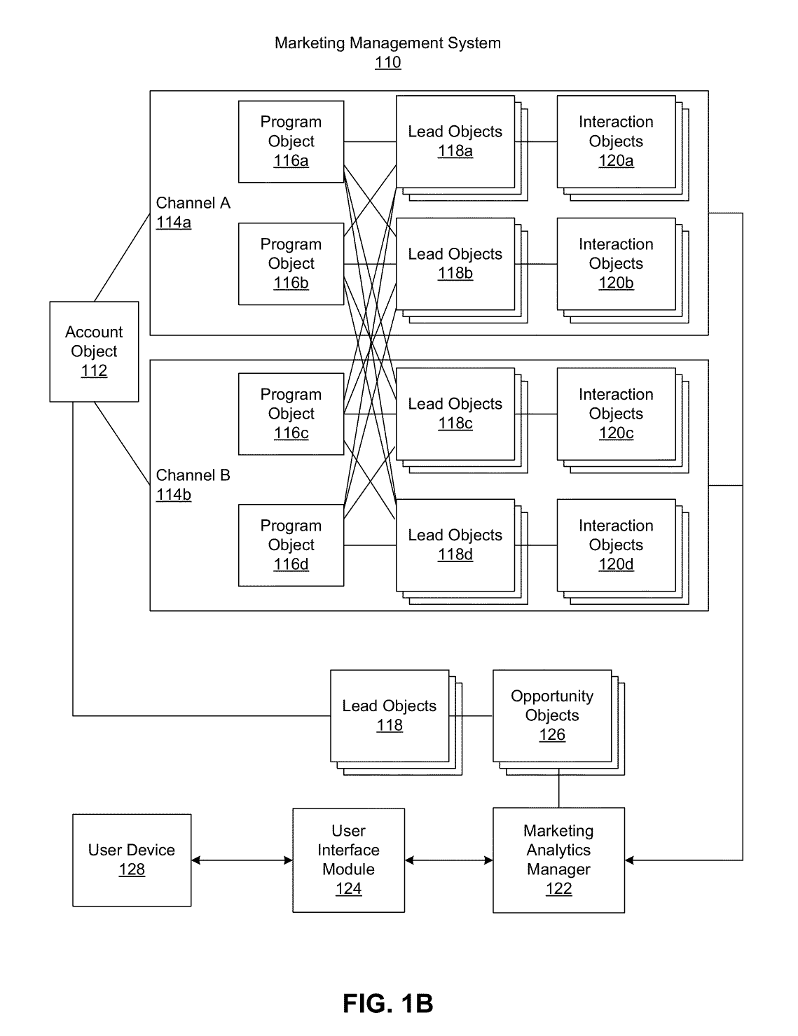

FIG. 1A illustrates a high level block diagram of cross-channel analytics in a marketing management system, in one embodiment. A first timeline 100a illustrates how a first lead (“L1”) 102a is created and acquired by a first program (“P1”) 104a. The first program 104a may be a marketing program in one of many program channels, such as a tradeshow booth, an email campaign, an invitation to sign up for a webinar, a blog, a call blitz, content syndication, direct mail, inbound contact, marketing prospecting, online advertising, referrals, road show, sales outbound, sponsorship, surveys, user group meeting, virtual trade show, webinar, and website form completion. FIG. 1A also illustrates that, although the first lead 102a was created and acquired by the first program 104a, the first lead 102a did not reach success in the first program 104a.

FIG. 1A and the other figures use like reference numerals to identify like elements. A letter after a reference numeral, such as “104a,” indicates that the text refers specifically to the element having that particular reference numeral. A reference numeral in the text without a following letter, such as “104,” refers to any or all of the elements in the figures bearing that reference numeral (e.g. “104” in the text refers to reference numerals “104a,” “104b,” “104c,” and/or “104d” in the figures). Four programs 104 are shown in FIG. 1A in order to simplify and clarify the description.

In one embodiment, a marketing management system may have default definitions for success of a marketing program 104. Depending on the program channel, different events may be defined, or tagged, as a success and a program may have several success events through a progression of events. For example, the first program 104a may have been a call blitz in which an account executive added the first lead 102a to a call blitz, engaged with the lead, connected with the lead, and scheduled a sales meeting. Each of these interactions may be logged into the marketing management system. One program success for this channel may be defined as creating a zero stage opportunity, or identifying a potential opportunity with the first lead 102a.

While the lead did not reach success for the first program 104a, the first lead 102a may have decided to sign up for a webinar, a second program (“P2”) 104b. After successfully engaging with the webinar, an indication that a first opportunity is created with the first lead 102a may be inputted as an opportunity creation event 106a in the marketing management system. A third program (“P3”) 104c may then be accessed by the first lead 102a, such as a website form. An indication that the opportunity has been “closed won,” meaning that the sale has been made, may be inputted as an opportunity closing event 108a in the marketing management system.

Even after the opportunity had been won, the lead 102a may have also become a member of a fourth program (“P4”) 104d. This fourth program 104d may be a different webinar educating the lead 102a about other offerings provided by the marketing and sales department. The fourth program 104d may not be included in the attribution analysis generated by the marketing management system. Here, the first program 104a may be attributed with acquiring the first lead 102a. The second program 104b and the third program 104c may be attributed with the success of the opportunity closing event 108a which resulted in generating revenue of $100 because the marketing management system received indications that the lead 102a reached success in those programs 104. While the lead 102a also reached success with the fourth program 104d, the lead 102a was added to the program 104d after the opportunity closing event 108a. Assuming that the cost of each program was $10, a return on investment may be calculated by the marketing management system, providing valuable information to the marketing department.

FIG. 1A also illustrates a second timeline 100b for a second lead 102b. For illustration purposes, the programs 104 on the second timeline 100b are the same programs from the first timeline 100a. As mentioned above, a marketing management system may have many different types of programs in the same and different channels. Different levels of success may be achieved by the second lead 102b in the same programs 104 participated in by the first lead 102a. A different opportunity creation event 106b may be created at a different time, such as after the lead 102b had participated in the first, second, and third programs 104. The fourth program 104d may also have the second lead 102b as a member, ultimately influencing the lead 102b to an opportunity closing event 108b. In this case, the acquisition of the second lead 102b may be attributed to the first program 104a while the successful revenue generation of $100 may be attributed to the second, third, and fourth programs 104 in which the lead reached success. In one embodiment, the attribution may be divided equally among the programs. In another embodiment, the attribution may be weighted based on the number of success levels achieved in each program. For example, the lead 102b may have reached additional levels of success in the second program 104b, such as engaging in the webinar by registering and clicking a link in a follow up email, attending the webinar, and downloading a whitepaper after the webinar. These interactions may represent three separate success levels for the same program 104b.

FIG. 1B illustrates a high level block diagram of a process for providing cross-channel analytics in a marketing management system, in one embodiment. The marketing management system 110 includes an account object 112 that may be associated with several channels 114 that represent different types of marketing program channels used by a marketing department to market to leads associated with the account. Channel A 114a may include two programs represented in the marketing management system 110 by a program object 116a and a program object 116b while channel B 114b may include two programs represented in the marketing management system 100 by a program object 116c and program object 116d. Lead objects 118 may be associated with the program objects 116. Interaction objects 120 may record the individual interactions a lead makes with respect to a program, such as clicking on a link sent via email to the lead to sign up for a webinar, attending a virtual webinar, downloading a white paper, scheduling a sales meeting, creating and/or closing opportunities, and so on.

The marketing management system 110 also includes a marketing analytics manager 122 that receives the information about channel activity, including interactions stored as interaction objects 120 by leads represented by lead objects 118 that may be associated with opportunities represented by opportunity objects 126 for a particular account represented by the account object 112.

The marketing management system 110 may associate an interaction object 120 with a lead object 118 based on the content of the interaction. For example, heavy web traffic by a lead associated with a lead object 118 may be associated with an interaction object 120. As another example, an indication that an email was opened by the lead associated with the lead object 118 may be associated with a separate interaction object 120. In this way, the lead objects 118 have been associated with interaction objects 120.

To attribute marketing activity to a newly created opportunity, represented by an opportunity object 126, marketing staff may use the marketing management system 110 to create the opportunity object 126, in one embodiment, and associate it with the account object 112. When creating the opportunity object 126, at least one lead associated with a lead object 118 must be identified as having a role in the opportunity represented by the opportunity object 126. Once the lead associated with the lead object 118 is associated with an opportunity object 126, the associated interaction objects 120 are also associated with the opportunity object 126. Lead objects 118 may be created through a user interface provided by the marketing management system 110 and inputted by marketing staff or through application programming interface (API) calls with an external sales platform or the company's system. In a further embodiment, marketing staff may import a list of leads into the marketing management system 110, such as a Microsoft Excel spreadsheet or comma separated value file. Lists of leads may be purchased through external vendors, for example. Enabling users of a marketing management system to attribute sales opportunity creations and closings with marketing programs and leads is further described in a related application, “Providing Marketing Analytics Related to a Sales Opportunity Over a Timeline in a Marketing Management System,” U.S. patent application Ser. No. 13/426,389, filed on Mar. 21, 2012, hereby incorporated by reference.

As illustrated in FIG. 1B, a user device 128 may interact with the marketing management system 110 through a user interface generated by a user interface module 124 to define various levels of success for program channels 114. Because a channel 114 may have customized levels of success dependent on the type of engagement involved in a program, a marketing management system 110 may use a system of standardized metadata tags, such as “acquisition” and “success,” for use in tagging program objects 116 and/or lead objects 118 in association with program objects 116. For example, a lead object 118a may reach “success” for a particular program object 116a, such as scheduling a sales meeting after receiving a phone call from a marketer.

Using metadata tags, or program tags, the marketing management system 110 may enable users to quickly identify which programs touched the leads that eventually matured into opportunities for each account. A first touch, or a program that acquired a lead, may be identified for any lead, as well as all touches that led to the opportunity creation may be quickly identified by the marketing management system 110 using metadata tags, regardless of the type of program or channel that was used to market to the lead. For example, a program object 116a and a program object 116b, representing two different email campaigns for an account, may both be associated with a lead object 118b. A program object 116c and a program object 116d, representing two different webinar presentations, may also both be associated with the same lead object 118b. Only one of the program objects 116 may be designated, or tagged, as the program object 116 that “acquired” the lead object 118b based on being the first touch that created the lead object 118b on the marketing management system 110. If the lead represented by the lead object 118b reached “success” in each of the program objects 116 that touched the lead, then those program objects 116 may be attributed to an opportunity creation event and/or opportunity closing event that occurred after the touches by the programs.

As a result of using the marketing management system 110, a user may quickly ascertain the owners, channels, specific programs, and other analytics that contribute to opportunity creation and close while also proving marketing's impact on the revenue cycle. This builds credibility by showing how marketing programs drive conversion and accelerate leads through the revenue cycle. Through several user interfaces provided by the marketing analytics manager 122, the user may analyze and compare opportunities represented by opportunity objects 126 for a particular account represented by an account object 112 in the marketing management system 110.

### System Architecture

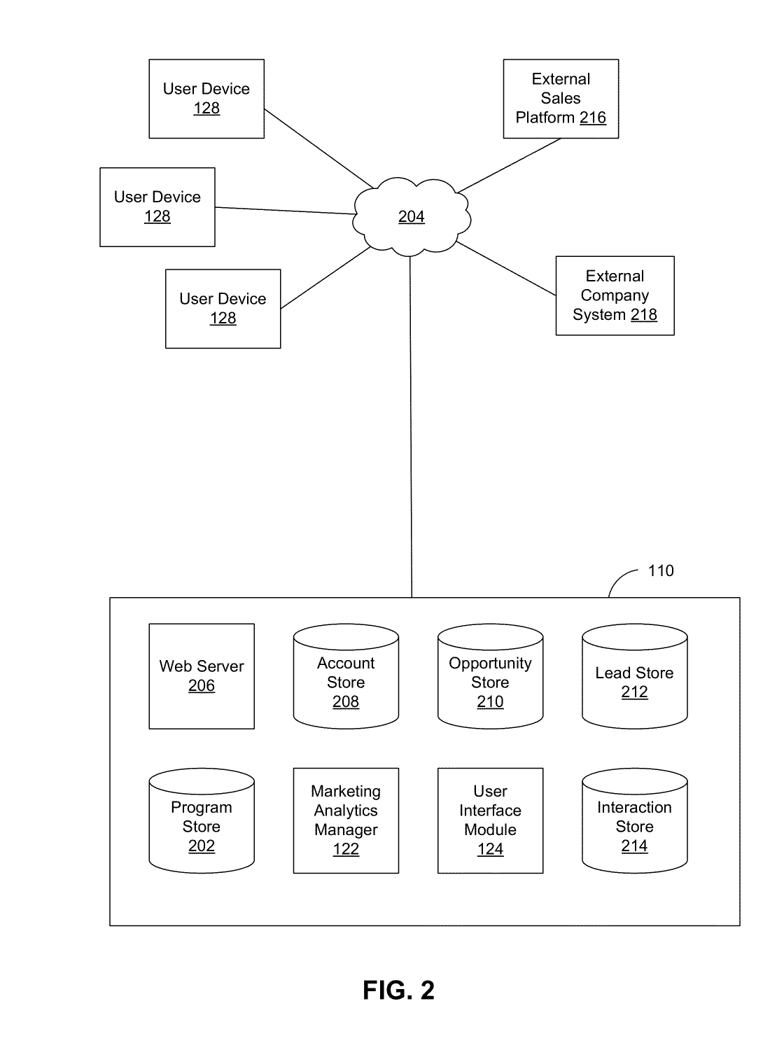

FIG. 2 is a high level block diagram illustrating a system environment suitable for providing metadata-based cross channel analytics in a marketing management system, in accordance with an embodiment of the invention. The system environment comprises one or more user devices 128, the marketing management system 110, a network 204, an external sales platform 216, and external company system 218. In alternative configurations, different and/or additional modules can be included in the system.

The user devices 128 comprise one or more computing devices that can receive user input and can transmit and receive data via the network 204. In one embodiment, the user device 128 is a conventional computer system executing, for example, a Microsoft Windows-compatible operating system (OS), Apple OS X, and/or a Linux distribution. In another embodiment, the user device 128 can be a device having computer functionality, such as a personal digital assistant (PDA), mobile telephone, smart-phone, etc. The user device 128 is configured to communicate via network 204. The user device 128 can execute an application, for example, a browser application that allows a user of the user device 128 to interact with the marketing management system 110. In another embodiment, the user device 128 interacts with the marketing management system 110 through an application programming interface (API) that runs on the native operating system of the user device 128, such as iOS and ANDROID.

In one embodiment, the network 204 uses standard communications technologies and/or protocols. Thus, the network 204 can include links using technologies such as Ethernet, 802.11, worldwide interoperability for microwave access (WiMAX), 3G, 4G, CDMA, digital subscriber line (DSL), etc. Similarly, the networking protocols used on the network 204 can include multiprotocol label switching (MPLS), the transmission control protocol/Internet protocol (TCP/IP), the User Datagram Protocol (UDP), the hypertext transport protocol (HTTP), the simple mail transfer protocol (SMTP), and the file transfer protocol (FTP). The data exchanged over the network 204 can be represented using technologies and/or formats including the hypertext markup language (HTML) and the extensible markup language (XML). In addition, all or some of links can be encrypted using conventional encryption technologies such as secure sockets layer (SSL), transport layer security (TLS), and Internet Protocol security (IPsec).

FIG. 2 contains a block diagram of the marketing management system 110. The marketing management system 110 includes a web server 206, an account store 208, an opportunity store 210, a lead store 212, an interaction store 214, a program store 202, a marketing analytics manager 122, and a user interface module 124. In other embodiments, the marketing management system 110 may include additional, fewer, or different modules for various applications. Conventional components such as network interfaces, security functions, load balancers, failover servers, management and network operations consoles, and the like are not shown so as to not obscure the details of the system.

The web server 206 links the marketing management system 110 via the network 204 to one or more user devices 128; the web server 206 serves web pages, as well as other web-related content, such as Java, Flash, XML, and so forth. The web server 206 may provide the functionality of receiving and routing messages between the marketing management system 110 and the user devices 128, for example, instant messages, queued messages (e.g., email), text and SMS (short message service) messages, or messages sent using any other suitable messaging technique. The user can send a request to the web server 206 to upload information, for example, contact information for leads that are stored in the lead store 212. Additionally, the web server 206 may provide API functionality to send data directly to native user device operating systems, such as iOS, ANDROID, webOS, and RIM.

A marketing analytics manager 122 gathers channel activity information about interactions with leads performed by marketing staff or other users of the marketing management system 110. Such information may include call records to leads, emails directed to leads, indications that emails were opened by leads, indications that emails were viewed but not opened, indications that leads were converted from prospects, indications that leads signed up for webinars, indications that leads downloaded documentation about products, indications that leads were converted into newly created opportunities, opening opportunities, closing opportunities, indications of “interesting moments” such as a lead downloading a whitepaper from the vendor's website, a lead opening an email from a sales representative, a lead attending a webinar, webpage visits, form fill-outs, tradeshows, email interactions, marketing program/campaign successes and so on. This information may be gathered from an external sales platform 216, such as salesforce.com, as well as an external company system 218, such as a customer relationship management (CRM) system offered by Microsoft, Netsuite, or SugarCRM. In one embodiment, the information may be manually inputted into the marketing management system 110 through a user interface. In another embodiment, the information about marketing activity may be gathered by the marketing management system 110 through application programming interface (API) calls to an external company system 218. In a further embodiment, a SOAP (Simple Object Access Protocol) or REST (REpresentation State Transfer) API may be used by the marketing management system 110 to receive an indication that an opportunity has been created.

Interactions gathered by the marketing analytics manager 122 may be saved as interaction objects 120 stored in the interaction store 214. The interaction objects 120 are also associated with lead objects 118 corresponding to the leads interacted with by marketing staff. These lead objects 118 are stored by the marketing management system 110 in the lead store 212.

A marketing analytics manager 122 further receives the information about interactions with leads through various programs regarding opportunities for accounts in a marketing management system 110. For example, when a sales representative receives a lead from marketing staff that has been nurtured and developed into a sales opportunity, the sales opportunity is inputted into the marketing management system 110 through a user interface, in one embodiment. In another embodiment, the sales opportunity may be inputted into the marketing management system 110 through an API call from an external company system 218 or through an external sales platform 216 upon identifying the sales opportunity. The marketing analytics manager 122, receiving the information that a lead associated with an account has been nurtured into a sales opportunity, generates an opportunity object 126 associated with an account object 108 in the marketing management system 110 associated with a lead object 114 and an interaction object 120 for the information about the sales opportunity received. Opportunity objects 126 are stored in the opportunity store 210, and account objects 112 are stored in the account store 208 in the marketing management system 110.

Program objects 116 represent various marketing programs that may be used by marketers to interact with leads, including blogs, call blitzes, content syndication, data quality, direct mail, email blasts, first touch direct mail, inbound, marketing prospecting, marketing qualified, micro-events, online advertising, referrals, roadshows, sales outbound, sponsorships, surveys, tradeshows, user group meetings, virtual trade shows, webinars, and website offerings. Programs may also be customized by marketing departments and stored as program objects 116 in a program store 202 in the marketing management system 110. A user interface module 124 provides one or more user interfaces for users of the marketing management system 110 to design, implement, and track performance of various marketing programs to interact with leads. These user interfaces enable users of a marketing management system 110 to analyze information about interactions with leads associated with opportunities for accounts as well as define metadata tags for programs, including acquisition and success tags, to provide cross-channel analytics in the marketing management system 110.

### Providing Cross-Channel Marketing Analytics

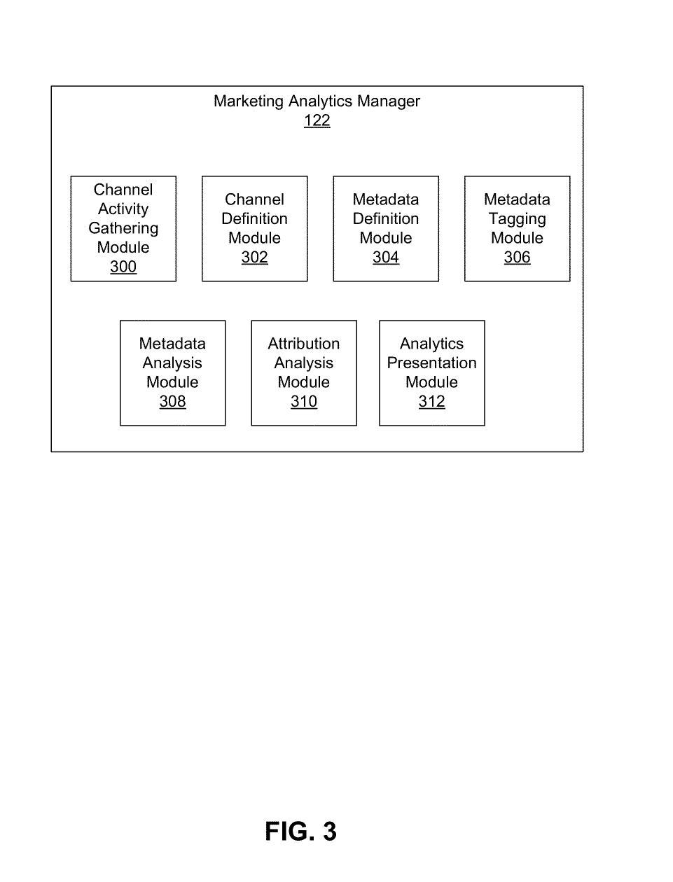

FIG. 3 illustrates a high level block diagram of the marketing analytics manager 122 in further detail, in one embodiment. The marketing analytics manager 122 includes a channel activity gathering module 300, a channel definition module 302, a metadata definition module 304, a metadata tagging module 306, a metadata analysis module 308, an attribution analysis module 310, and an analytics presentation module 312. These modules may perform in conjunction with each other or independently to provide cross-channel analytics in a marketing management system 110.

A channel activity gathering module 300 gathers channel activity from one or more channels associated with an account in the marketing management system 110. Channel activity may include interactions with leads through various programs, such as email campaigns, webinars, and trade shows. Different levels of activity in a particular program may be gathered, such as receiving an indication that an email was opened, a link in the email was clicked on, a website form was completed, a virtual webinar sign up form was completed, and so on. Channel activity may be gathered from program objects 116, lead objects 118, interaction objects 120, opportunity objects 126, and/or account objects 112 associated with channels 114.

A channel definition module 302 enables users of the marketing management system 110 to define channels 114 and programs provided in the channels 114. In one embodiment, a channel 114 may be defined to have one or more progression statuses for the programs provided in the channel. For example, a blog channel may be described as a banner or link to a gated asset from a marketing department's blog on the Internet. If a user clicks on a banner or link in the blog and/or fills out a form on the landing page that the user was directed to, the user may be “engaged,” the only progression status for the blog channel. In another channel, such as an email blast channel, several progression stages may be defined using the channel definition module 302, including “sent,” “opened,” “clicked,” and “unsubscribed.” In this case, where an email blast is sent to a potential lead with the objective of persuading the reader to click a link in the email, only the “clicked” progression status may be indicative of a “success” progression stage. The metadata definition module 304 may be used to define “success” and other metadata tags, in one embodiment. In another embodiment, the channel definition module 302 may be used to identify the one or more metadata tags to be associated with the one or more progression stages of a program in a channel 114. In this way, a blog program channel may have a different definition of success than an email blast program channel. Accordingly, a program channel may have multiple “success” tags associated with multiple progression stages.

A metadata definition module 304 enables users of a marketing management system 110 to define metadata tags to be associated with various objects in the marketing management system 110, including program objects 116, lead objects 118, interaction objects 120, opportunity objects 126, and/or account objects 112. For example, program metadata may include a period, a cost, a success flag, a date of reaching success, a channel type, and a listing of identifying information of acquired leads. A period may be a range of dates during which the program object 116 associated with the program was active. Cost metadata may include the cost of producing the program. Success flag metadata may include a yes/no indication of whether the program reached success, in one embodiment. The success flag may be marked “no” by default until a particular progression stage is reached by the lead, as defined by the channel definition module 302 and discovered by the metadata analysis module 308 in analyzing the received channel activity information from the channel activity gathering module 300, in one embodiment. A channel type metadata tag for a program may include identifying information of the particular channel 114 that is associated with the program. Acquisition metadata may include identifying information of lead objects 118 that were acquired by the program. In one embodiment, acquisition metadata may include names of new contacts not in the marketing management system 110.

Other types of metadata may be defined by the metadata definition module 304, such as attribution metadata. For example, a “first touch” attribution may be defined for lead objects 118 that may include identifying information of the program objects 116 responsible for creating the lead in the marketing management system 110. As another example, an “even spread” attribution may be defined for a lead object, indicating two or more programs that have been attributed with an opportunity creation event in the marketing management system 110. A lead may have reached success status in multiple programs, resulting in the creation of multiple opportunities. In this case, the attribution of opportunity dollars will be evenly distributed or spread among the programs where the lead reached success statuses. As a result, metadata tags may be customized for different channels, enabling cross-channel analytics using the same metadata tags, such as program success.

A metadata tagging module 306 generates metadata tags for objects in the marketing management system 110. In one embodiment, business logic rules applied by the metadata tagging module 306 may be used to generate one or more metadata tags for various objects in the marketing management system 100, including program objects 116, lead objects 118, interaction objects 120, account objects 112, and opportunity objects 126. Continuing a previous example in which program metadata may include a period, a cost, a success flag, a date of reaching success, a channel type, and a listing of identifying information of acquired leads, a program object 116 may be “tagged” with metadata by the metadata tagging module 306 based on information received from the marketing management system 110. Information about a particular program, such as an online advertisement directing potential leads to fill out a form on a website, may be inputted into the marketing management system 110 through a user interface on the marketing management system 110 or through various application programming interfaces (APIs) delivering the information from an external sales platform 216 or an external company system 218, in one embodiment. Other information related to a lead regarding a particular program, such as whether the lead reached success by performing one or more defined actions, may be retrieved from one or more interaction objects 120 associated with the lead object 118 representing the lead. An interaction object 120 may include such information as whether the lead completed the form after clicking on the online advertisement, for example.

The metadata tagging module 306 may also apply other rules for other tags, such as attribution tags for acquisition of leads and attribution for success events, such as opportunity creation events and opportunity closing events. A lead acquisition metadata tag may be generated for a program object 116 that is a first touch for a lead. A success metadata tag may be generated for a lead object 118 in relation to a particular program object 116 upon the lead reaching a progression stage of the program by performing the corresponding action, such as the lead filling out and submitting a form on a website after clicking on a link in an online advertisement. An opportunity object 126 that is generated upon creation of an opportunity for a particular lead may be associated with one or more attribution metadata tags identifying the one or more program objects 116 with which the particular lead associated with the opportunity reached success. These program objects 116 may be identified using the success metadata tags generated for the lead object 118 for the particular lead associated with the opportunity, in one embodiment.

A metadata analysis module 308 provides analytical information about metadata tags in the marketing management system 110. A first touch analysis of programs for an account may be provided by the metadata analysis module 308, enabling users of the marketing management system 110 to quickly identify programs that have been successful in acquiring leads and which leads have room for improvement. A touch may be defined as any marketing program in which the lead is a member and created by the program and/or reached success status. The touch date is the date when the lead is acquired by the program or reached success status for the program. Other metadata analytics may be performed by the metadata analysis module 308, such as a return on investment (ROI) analysis based on cost and attributed sales revenue for programs, an analysis of acquired leads by dates and programs across multiple channels, an analysis of program success across multiple channels, and so on. In one embodiment, a user of a marketing management system 110 may select from predefined metrics using the metadata analysis module 308, such as a pipeline generated metric, pipeline open metric, opportunity creation units metric, opportunity closing units metric, expected revenue metric, revenue metric, and revenue to investment metric. In another embodiment, a user may define various analytics or metrics using the metadata analysis module 308.

A pipeline generated metric provides information, on a per program level, about how much expected revenue a program generated through opportunities created in the marketing management system 110. This metric is calculated using the revenue value of an opportunity divided by the number of programs that reached success before the creation of the opportunity. In the case of multiple opportunities for a single lead, the pipeline generated metric may be cumulative. In contrast, a pipeline open metric provides information, on a per program level, about how much expected revenue a program generated through open opportunities in the marketing management system 110, or opportunities that have not yet been closed or won.

An opportunity creation units metric, also referred to as opportunity units, differs from an opportunity closing units metric, also referred to as opportunity units closed won or opportunity closed lost depending on whether the sale is made because each metric relies on different dates of opportunities. Each opportunity may have an opportunity creation date and an opportunity closing date. An expected closing date may usually be required by an external system or by the marketing management system when an opportunity is created. This closing date, typically set in the future, can be used to determine attribution or other analytics for either opportunity creation or opportunity closed won. An opportunity with no closing date indicates that the opportunity is still open, meaning that the sales department has not closed the sale. An opportunity creation units metric, on a per program level, provides an indication of the influence a program may have on creation of opportunities for the account. An opportunity closing units metric provides an indication of how many closed opportunities may be attributed to a program. Opportunity closing units metrics may refer to either an opportunity closed won or an opportunity closed lost. Opportunity closed won is usually considered in attribution analytics, not opportunity closed lost. An expected revenue metric provides, on a per program basis, the amount of revenue expected to be attributed to a program based on the associated opportunities. A revenue metric provides the actual revenue won through a closed opportunity or won opportunity for the program. In one embodiment, the total expected revenue and the total revenue won are evenly spread among the programs attributable to the creation and closing of opportunities. An opportunity may close without being won, meaning that the opportunity was lost. In another embodiment, the total expected revenue and the total revenue won may be distributed to programs based on first touch, or acquisition of the one or more leads by the programs. In a further embodiment, a marketing department may attribute expected revenue and revenue won using weights for channel types of the programs. In yet another embodiment, a customized attribution scheme may be used to attribute expected revenue and revenue won to programs that contributed to the opportunity creation and closing (won).

A revenue to investment metric provides a percentage indicating the return on investment or rate of return on a per program basis. For example, a program may cost $10 to run, but may influence a lead to create and eventually close an opportunity worth $100. Other programs may have also influenced the lead to close the opportunity. Assuming that each program costs $10 and there were three programs that reached success for the opportunity before the opportunity closing date, the revenue won per program was $33.33 and the revenue to investment metric may be provided as a percentage, 333%. This metric is calculated by taking the revenue won per program divided by the cost of the program. In other embodiments, different methods of calculating the revenue to investment metric may be used, incorporating weights and other factors into the calculation. For example, where attribution of revenue is given to the program the first touched the lead, or acquired the lead and assuming the same cost of the program ($10) and revenue won from the opportunity ($100), the revenue to investment metric may be provided as a percentage, 1000%.

An attribution analysis module 310 provides different attribution analytics for programs in a marketing management system 110. In one embodiment, an acquisition attribution analysis may allocate the value of an opportunity to the program (with cost) in which the lead is created by the program. A lead may only be acquired by one program. The acquisition program and acquisition data may be changed in the marketing management system 110. The opportunity amount is attributed evenly among all acquiring touches for all leads that are associated with the opportunity. A success attribution analysis may allocate the value of an opportunity across all programs (with cost) in which the lead reached a success status. As a result, the opportunity amount is attributed evenly among all success touches for all leads that are associated with the opportunity. For example, a first program and a second program may be associated with a first lead that reached success in both programs. A third program may be associated with a second lead that also reached success. The first and second leads may be associated with an opportunity worth $100 in revenue. As a result, the opportunity amount is evenly distributed among the first, second, and third programs ($33.33 each). In these ways, various metrics may be calculated based on metadata tags for programs that may be very different, such as phone call blitzes and online advertisements.

In one embodiment, two sets of metrics may be determined by the marketing analytics manager 122: metrics that measure the program influence towards opportunity creation and metrics that track the program influence towards opportunity close (aka revenue). Touches that happened before opportunity creation are considered for attribution of program influence towards opportunity creation. Touches that happened before opportunity close are considered for attribution of program influence towards opportunity close.

An analytics presentation module 312 provides cross-channel analytics based on metadata in one or more user interfaces to users of the marketing management system 110. The analytics presentation module 312 may provide these types of metrics along a timeline based on the touch date of attribution, in one embodiment. In other embodiments, different user interfaces may be used to provide this information, such as charts providing the above-described metrics per program, data visualizations, and data flow diagrams.

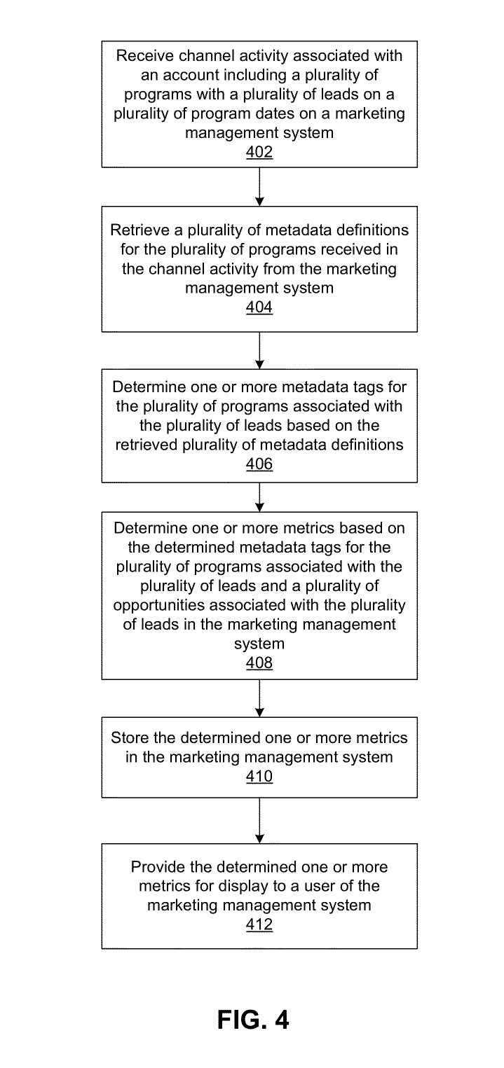

FIG. 4 illustrates a flow chart diagram depicting a process of providing cross-channel marketing analytics in a marketing management system, in accordance with an embodiment of the invention. Channel activity associated with an account including a plurality of programs with a plurality of leads on a plurality of program dates on a marketing management system is received 402. Channel activity may be received from interaction objects and other information received from external sales platforms, external company systems, as well as directly inputted into the marketing management system 110. Channel activity may include receiving information about an email blast being sent to potential leads, online advertisements being clicked on, call blitzes being performed by marketing and sales teams, invitations to webinars being accepted and completed, tradeshow information being gathered for potential leads, and so on.

After the channel activity is received 402, a plurality of metadata definitions for the plurality of programs received in the channel activity are retrieved 404 from the marketing management system. The metadata definitions may be predetermined by users of the marketing management system 110 that defined the plurality of programs received in the channel. Metadata definitions may include a plurality of business logic rules to be applied in determining metadata tags based on the metadata definitions. Metadata definitions may also include identifying information of types of objects to associate the metadata tags, such as lead objects 118, program objects 116, account objects 112, and opportunity objects 126. Metadata definitions may also identify the types of information used in generating metadata tags, such as using information retrieved from the marketing management system 110, interaction objects 120, and information received from an external sales platform 216 and/or an external company system 218.

One or more metadata tags are determined 406 for the plurality of programs associated with the plurality of leads based on the retrieved plurality of metadata definitions. Metadata tags may be determined 406 for various objects in the marketing management system 110 based on the plurality of programs associated with the plurality of leads. In one embodiment, a lead may be identified in an opportunity creation event. As a result, a metadata tag may be determined for the lead as being associated with an opportunity creation event. Further, the plurality of programs associated with that lead that either acquired the lead or in which the lead reached success may have an attribution tag associated with the lead and the opportunity creation event. Various types of metadata tags may be determined 406 based on the plurality of programs associated with the plurality of leads, including a program time period, a cost, a success flag, a date of reaching success, a channel type, a listing of identifying information of acquired leads, a set of defined progression statuses, a super-program such as a parent program which may include a variety of programs relevant to the defined theme of super-program, and so forth.

One or more metrics are determined 408 based on the determined metadata tags for the plurality of programs associated with the plurality of leads and a plurality of opportunities associated with the plurality of leads in the marketing management system. One metric that may be determined 408 based on the determined metadata tags comprises a first touch attribution metric, identifying the program that acquired the lead, generating the lead in the marketing management system 110. Other metrics that may be determined 408 include multi-touch attribution, acquisition attribution, success attribution, multiple opportunity acquisition attribution, multi-lead single opportunity acquisition attribution, and other metrics that may measure performance of programs across multiple channels.

The determined one or more metrics are then stored 410 in the marketing management system. Metrics may be stored as metadata tags in association with lead objects 118, program objects 116, account objects 112, and/or opportunity objects 126, in one embodiment. In another embodiment, metrics may be stored as separate objects in the marketing management system 110. The determined one or more metrics are then provided 412 for display to a user of the marketing management system. The metrics may be provided 412 for display in various user interfaces, including charts, data flow diagrams, data visualizations, and the like.

### Customizable Cross-Channel Analytics in a Marketing Management System

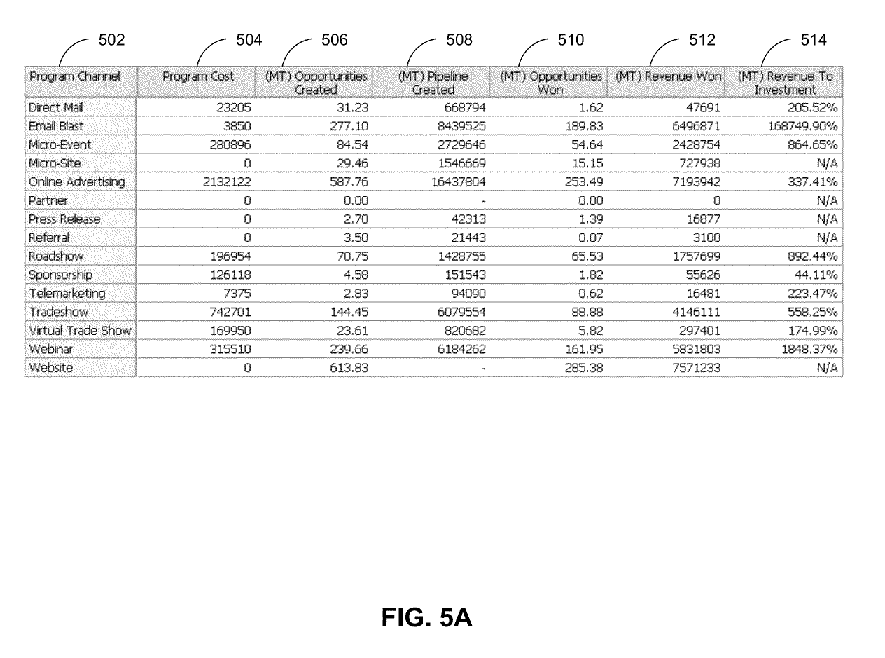

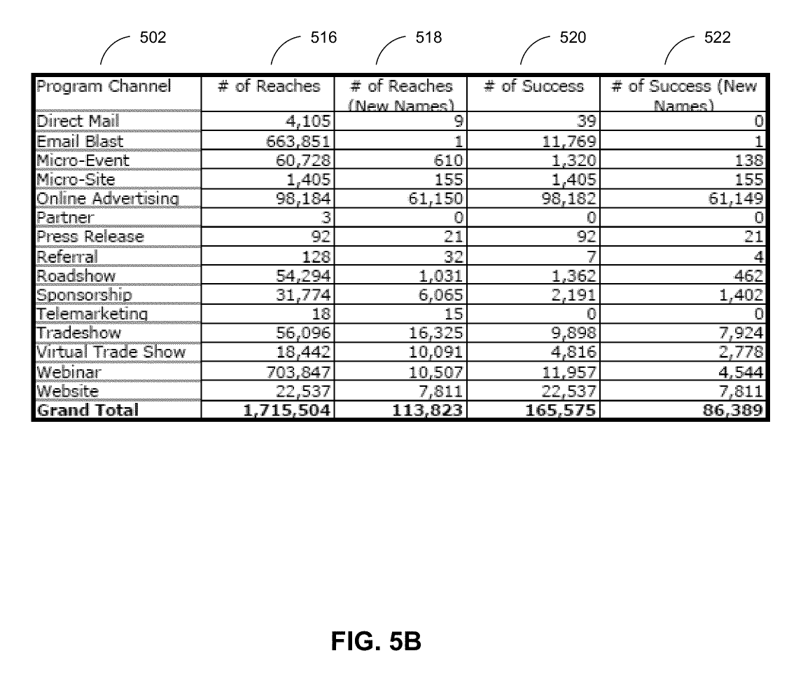

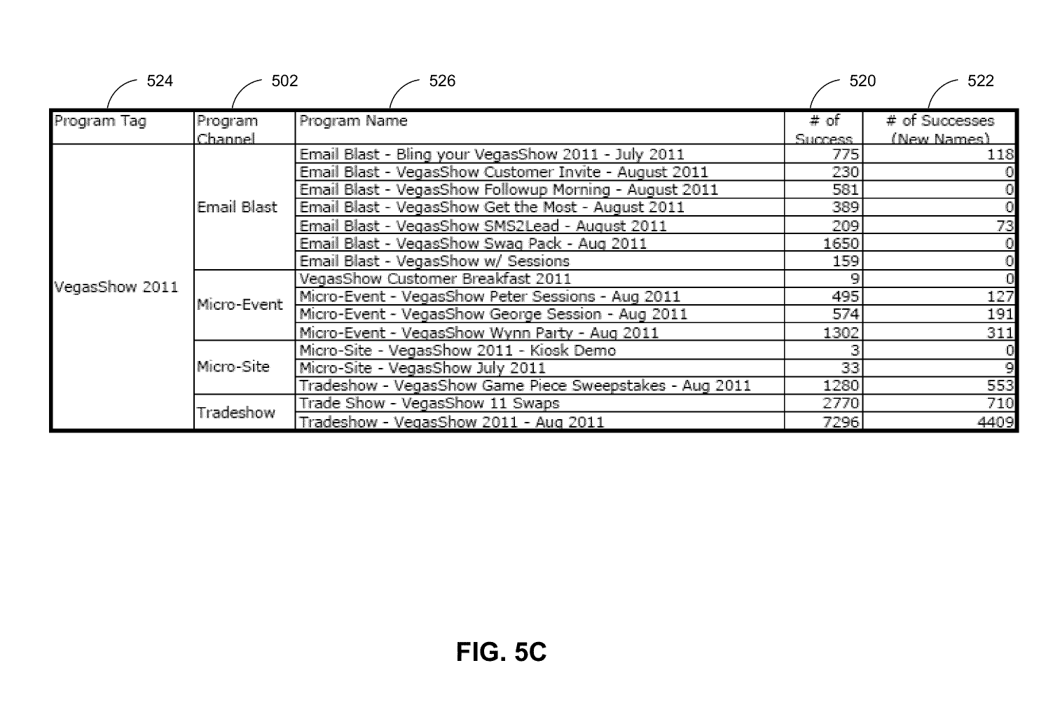

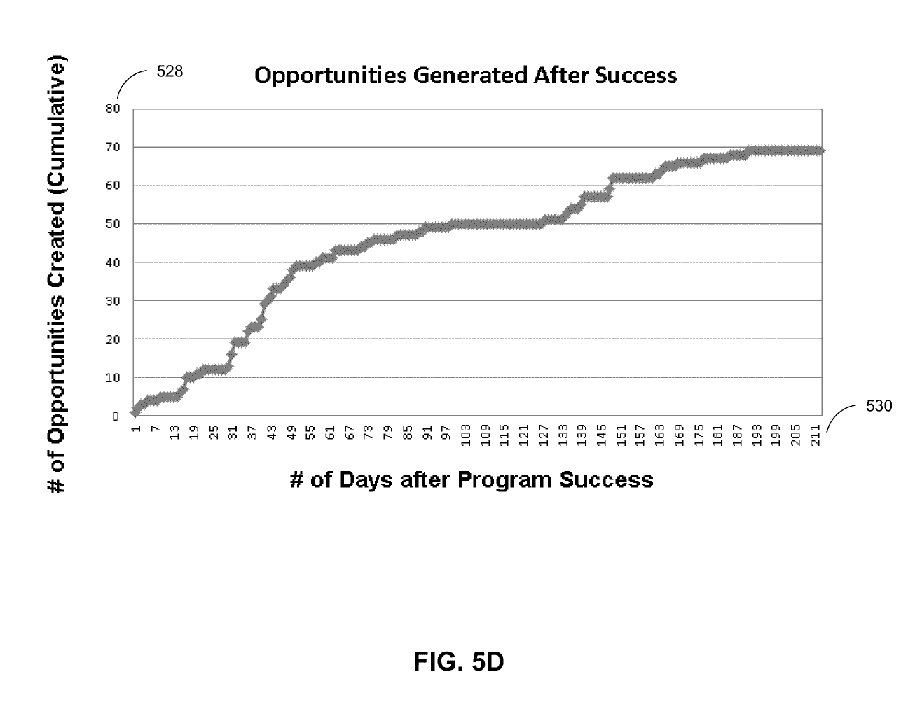

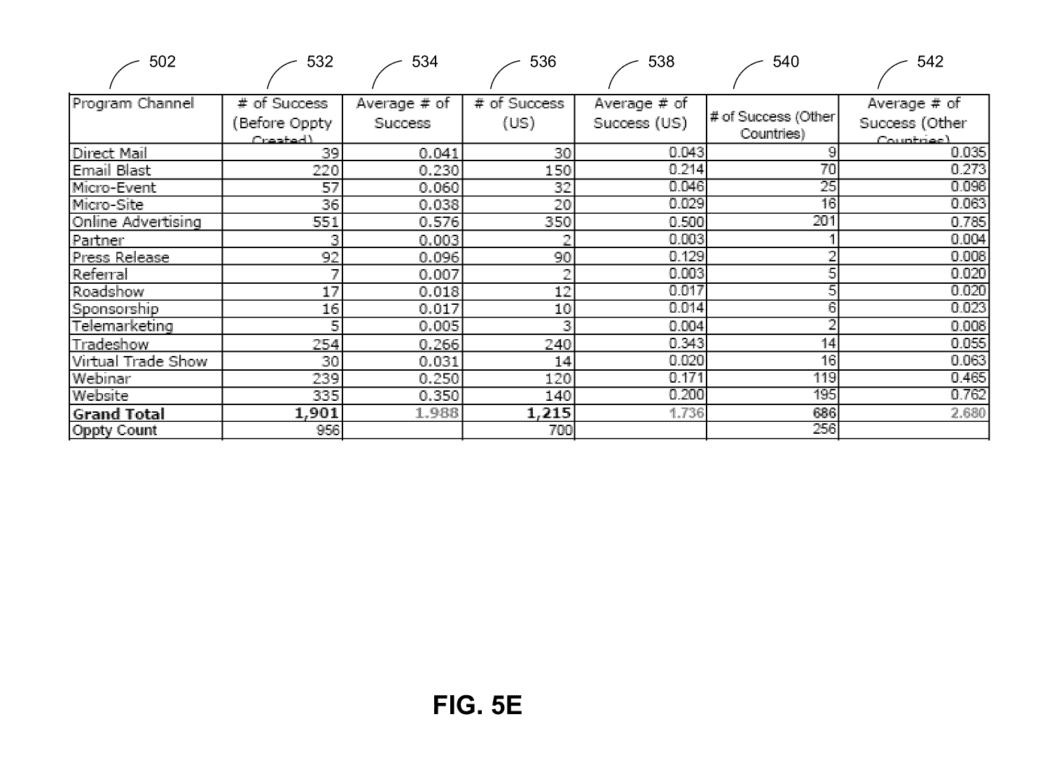

FIGS. 5A-E include example screenshots of charts and a graph illustrating some cross-channel analytics in a marketing management system, in accordance with an embodiment of the invention. FIG. 5A illustrates a chart providing cross-channel analytics in a marketing management system 110, providing various metrics such as opportunities created, pipeline created, opportunities won, revenue won, and revenue to investment as described above in relation to FIG. 3. FIG. 5A illustrates a chart having multiple columns, including a program channel column 502, a program cost column 504, an opportunities created column 506, a pipeline created column 508, an opportunities won column 510, a revenue won column 512, and a revenue to investment column 514. In one embodiment, more or fewer columns may be included in the chart based on the selected metrics, or analytics.

FIG. 5A shows various metrics that may be gathered for different types of program channels, including direct mail, email blast, micro-event, micro-site, online advertising, partner, press release, referral, roadshow, sponsorship, telemarketing, tradeshow, virtual trade show, webinar, and website. As illustrated in the opportunities created column 506, the number of opportunities created may be expressed with two decimal places, meaning that attribution of an opportunity may be divided among several leads. Providing the information about marketing programs in this chart enables a marketer to generate different cross-channel analytics, in one embodiment. Quickly scanning the revenue to investment column 514, a marketer may notice that the email blast program channel has a revenue to investment percentage of 168,749.90%, the largest percentage for all program channels. By comparison, the most costly program channel, online advertising costing $2,132,122, has a revenue to investment percentage of only 337.41%. The program tags of program cost and program date (not illustrated) may be used in generating these cross channel analytics metrics. In another embodiment, the marketing management system 110 may generate different cross-channel attribution analytics using metadata-based program tags.

FIG. 5B illustrates a second chart showing a marketing department's annual performance, the chart having multiple columns including a program channel column 502, a reaches column 516, a new names reaches column 518, a success column 520, and a new names success column 522. Without cross-channel analytics, the reaches column 516 and the new names reaches column 518 may be generated for the different program channels in the program channel column 502. For example, the marketing department may have reached a grand total of over 1.7 million leads, as indicated in the “Grand Total” row in the reaches column 516. Out of that number, 113.8 thousand leads are new leads, or new names as indicated in the new names reaches column 518 in the same row. However, these numbers may be misleading because the email blast program channel had 663.8 thousand reaches, but only 11.7 thousand people opened the emails resulting in success. Furthermore, only 1 new name was obtained from that email blast campaign, as indicated in the new names reaches column 518.

Using the success metadata tag, one of many program tags in the marketing management system 110, the success column 520 and the new names success column 522 may be generated for each program channel in the program channel column 502. As mentioned above, each program channel may have one or more definitions of what constitutes a “success” for a lead interacting with a program in that program channel. For example, a lead opening an email, clicking a link inside the email, and filling out a form on a website after clicking the link may each be counted as different “successes” as customized by a marketing department, in one embodiment. Looking at success figures in the success column 520 and new names success column 522, the marketing department had a grand total of 165.6 thousand successes, and about half of those, 86,389, were new leads.

In contrast, without success metadata tags, a listing of criteria of what may constitute a countable success would be displayed for the “grand total,” such as total number of leads who opened email, attended a micro-event, visited a micro-site and filled out a form at the micro-site, clicked an online advertisement, filled out a form after clicking the online advertisement, . . . is 165,575. Moreover, such a report would have fixed criteria for each program. Using customizable metadata tags in the marketing management system 110, different criteria may be specified for what counts as reaching success for any program channel, in one embodiment.

FIG. 5C illustrates a third chart illustrating how additional program tags in a marketing management system 110 may be used generate additional cross-channel marketing analytics, the chart having multiple columns including a program tag column 524, a program channel column 502, a program name column 526, a success column 520, and a new names success column 522. As shown in FIG. 5C, all programs that have been tagged with the program tag of “VegasShow 2011” are displayed in the chart, as indicated by each row of the program name column 526 and grouped by program channel. The number of successes and new names successes are displayed for each program in the success column 520 and the new names success column 522. As a result, cross-channel analytics may be generated based on these metrics, such as comparing the number of successes in different marketing channels, the new names success for different marketing channels, and so forth. For example, about half of the successes of the micro-site program, “Tradeshow—VegasShow Game Piece Sweepstakes—Aug. 2011” were new names, making it more successful in obtaining new leads. As a comparison, the micro-event program “Micro-Event—VegasShow Wynn Party—Aug. 2011” had 311 new names successes out of the 1302 successes counted by the marketing management system 110. In another embodiment, the marketing management system 110 may generate additional cross-channel marketing analytics, such as a ratio of new names successes to successes.

FIG. 5D illustrates a graph showing additional cross-channel analytics of the “VegasShow 2011” program illustrated in FIG. 5C, illustrating the number of new opportunities created as functions of days after program successfully generated the new leads in the marketing management system 110. For example, for all programs tagged as “VegasShow 2011” in the marketing management system 110, after about three months, or ninety days, roughly fifty new opportunities are generated. Because program successes occurred at different times, this type of analytical measure of marketing programs is more difficult and complicated to generate without using metadata-based program tags such as “program success.” Furthermore, the program tag of “VegasShow 2011” enables marketers to tag programs in different channels that would otherwise be unrelated in the marketing management system 110. As a result, the program tag “VegasShow 2011” enables the graph illustrated in FIG. 5D to be generated. Other graphs may be generated in other embodiments using one or more program tags, metadata attached to programs in the marketing management system 110.

FIG. 5E illustrates a fourth chart illustrating additional cross-channel marketing analytics in the marketing management system 110, the chart having multiple columns including a program channel column 502, a success before opportunity created column 532, an average number of success column 534, a success in the US column 536, an average number of success in the US column 538, a success in other countries column 540, and an average number of success in other countries column 542. This chart provides cross-channel marketing analytics that may be useful to marketing departments working on planning and budgeting based on having a target number of opportunities to hit. In this example, the success before opportunity created column 532 provides the number of successes that occurred by opportunity is created. With fifteen different program channels, the grand total of successes is 1901, as indicated in the “Grand Total” row of the column, the sum of the previous rows in the column. The company has 956 opportunities, as indicated in the “Oppty Count” row of the same column, retrieved by the marketing management system 110. As a result, the average number of successes to create one opportunity is 1901 divided by 956, or 1.988, indicated in the “Grand Total” row of the average number of success column 534. The average number of success may breakdown by successes in the US (1.736) versus successes in other countries (2.680) using similar calculations. Thus, informative data analytics may be generated using metadata associated with programs, or program tags that include program date, location of opportunities, and so on.

As illustrated in the above examples, different types of cross-channel analytics may be generated using metadata tags in the marketing management system 110, including complex metrics such as acquisition attribution, first touch attribution, and revenue attribution, as well as informative analytics such as number of successes per program, graphs of datasets over customizable functions, and so on. These analytics may be performed on all programs regardless of the type of program channel based on the metadata tags defined for each program. Program tags, as a result, enable marketers to analyze different types of marketing programs and activities in countless ways.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for providing marketing analytics for different types of programs in a marketing management system, the method comprising:
receiving channel activity associated with an account on a marketing management system, the channel activity comprising a plurality of interactions by a plurality of leads with a plurality of programs provided on at least two program channels of different types, the plurality of leads interacting with the plurality of programs on a plurality of program dates;
retrieving a plurality of metadata definitions for the plurality of interactions with the plurality of programs received in the channel activity;
determining one or more metadata information items for the plurality of programs associated with the plurality of leads based on the retrieved plurality of metadata definitions;
determining one or more metrics for the plurality of programs associated with the plurality of leads and one or more opportunities associated with the account based on the determined one or more metadata information items;
storing the determined one or more metrics in the marketing management system; and
providing the determined one or more metrics for display to a viewing user of the marketing management system.

2. The method of claim 1, wherein receiving channel activity associated with an account on a marketing management system further comprises:
receiving a first interaction of the plurality of interactions between a lead of the plurality of leads associated with the account and a first program of the plurality of programs provided in a first channel on the marketing management system; and
receiving a second interaction of the plurality of interactions between the lead and a second program of the plurality of programs provided in a second channel on the marketing management system.

3. The method of claim 1, wherein receiving channel activity associated with an account on a marketing management system further comprises:
receiving from a user interface on the marketing management system the channel activity about the plurality of interactions of the plurality of leads with the plurality of programs.

4. The method of claim 1, wherein receiving channel activity associated with an account on a marketing management system further comprises:
receiving from an external company system the channel activity about the plurality of interactions of the plurality of leads with the plurality of programs.

5. The method of claim 1, wherein receiving channel activity associated with an account on a marketing management system further comprises:
receiving from an external sales platform the channel activity about the plurality of interactions of the plurality of leads with the plurality of programs.

6. The method of claim 1, wherein determining a metric of the one or more metrics for the plurality of programs further comprises:
for a particular opportunity of the one or more opportunities associated with the account, selecting one or more programs to be associated with the particular opportunity that reached success based on the determined one or more metadata information items;
associating the particular opportunity with the selected one or more programs of the plurality of programs that reached success; and
determining the metric as an attribution of the particular opportunity to the selected one or more programs.

7. The method of claim 6, wherein the particular opportunity is associated with one or more particular leads and wherein selecting one or more programs to be associated with the particular opportunity that reached success based on the determined one or more metadata information items further comprises:
determining the one or more metadata information items indicating that the one or more particular leads reached success in the one or more programs by performing one or more interactions with the one or more programs using the retrieved plurality of metadata definitions; and
selecting the one or more programs to be associated with the particular opportunity based on the determined one or more metadata information items.

8. The method of claim 1, wherein determining a metric of the one or more metrics for the plurality of programs further comprises:
for a particular opportunity of the one or more opportunities associated with the account, selecting one or more programs associated with the particular opportunity based on one or more metadata information items indicating that one or more leads associated with the particular opportunity were acquired by the one or more programs; and
associating the particular opportunity with the selected one or more programs based on the one or more metadata information items indicating that the one or more leads associated with the particular opportunity were acquired by the selected one or more programs.

9. A method for analyzing programs in different program channels in relation to opportunities in a marketing management system, the method comprising:
retrieving a plurality of interactions associated with at least one opportunity for an account in the marketing management system, where the at least one opportunity is associated with at least one lead associated with the account;
determining one or more programs associated with the at least one lead;
determining one or more metadata tags for the one or more programs associated with the at least one lead based on the retrieved plurality of interactions;
determining a success flag for each of the one or more programs associated with the at least one lead, each success flag determined based on the retrieved plurality of interactions associated with the at least one opportunity; and
storing the one or more success flags for the one or more programs associated with the at least one lead in the marketing management system.

10. The method of claim 9, the method further comprising:
determining an attribution of a subset of the one or more programs to the at least one opportunity in the marketing management system based on each program of the subset of the one or more programs being associated with one or more affirmative success flags.

11. The method of claim 10, wherein an affirmative success flag for a program is determined based on the at least one lead performing an interaction with the program defined as reaching success for the program.

12. The method of claim 10, wherein determining one or more metadata tags for the one or more programs associated with the at least one lead based on the retrieved plurality of interactions further comprises:
for each opportunity having an opportunity closing date,
determining a subset of the one or more programs associated with one or more affirmative success flags as comprising one or more programs having a program date before the opportunity closing date of the each opportunity;
determining a count of the subset of the one or more programs associated with one or more affirmative success flags;
determining a revenue per program metric based on a revenue value of the each opportunity divided by the count of the subset of the one or more programs associated with one or more affirmative success flags; and
storing the revenue per program metric as a metadata tag for the subset of the one or more programs associated with one or more affirmative success flags in the marketing management system for the each opportunity.

13. The method of claim 10, wherein determining one or more metadata tags for the one or more programs associated with the at least one lead based on the retrieved plurality of interactions further comprises:
for each opportunity having an opportunity creation date,
determining a subset of the one or more programs associated with one or more affirmative success flags as comprising one or more programs having a program date before the opportunity creation date of the each opportunity;
determining a count of the subset of the one or more programs associated with one or more affirmative success flags;
determining an expected revenue per program metric based on a revenue value of the each opportunity divided by the count of the subset of the one or more programs associated with one or more affirmative success flags; and
storing the expected revenue per program metric as a metadata tag for the subset of the one or more programs associated with one or more affirmative success flags in the marketing management system for the each opportunity.

14. The method of claim 10, wherein determining one or more metadata tags for the one or more programs associated with the at least one lead based on the retrieved plurality of interactions further comprises:
for each opportunity having an opportunity closing date,
determining a subset of the one or more programs associated with one or more affirmative success flags as comprising one or more programs having a program date before the opportunity closing date of the each opportunity;
determining a count of the subset of the one or more programs associated with one or more affirmative success flags;
determining a revenue to investment per program percentage based on a revenue value of the each opportunity divided by the count of the subset of the one or more programs associated with one or more affirmative success flags divided by a program cost per program multiplied by a value of one hundred; and
storing the revenue to investment per program percentage as a metadata tag for the subset of the one or more programs associated with one or more affirmative success flags in the marketing management system for the each opportunity.

15. The method of claim 10, wherein determining one or more metadata tags for the one or more programs associated with the at least one lead based on the retrieved plurality of interactions further comprises:
for each opportunity having an opportunity creation date,
determining a subset of the one or more programs associated with one or more affirmative success flags as comprising one or more programs having a program date before the opportunity creation date of the each opportunity;
determining a count of the subset;
determining an opportunity creation unit per program metric based on a value of one divided by the count; and
storing the opportunity creation unit per program metric as a metadata tag for the subset of the one or more programs associated with one or more affirmative success flags in the marketing management system for the each opportunity.

16. The method of claim 10, wherein determining one or more metadata tags for the one or more programs associated with the at least one lead based on the retrieved plurality of interactions further comprises:
for each opportunity having an opportunity closing date,
determining a subset of the one or more programs associated with one or more affirmative success flags as comprising one or more programs having a program date before the opportunity closing date of the each opportunity;
determining a count of the subset;
determining an opportunity closing unit per program metric based on a value of one divided by the count; and
storing the opportunity closing unit per program metric as a metadata tag for the subset of the one or more programs associated with one or more affirmative success flags in the marketing management system for the each opportunity.

17. The method of claim 10, wherein determining one or more metadata tags for the one or more programs associated with the at least one lead based on the retrieved plurality of interactions further comprises:
for each opportunity having an opportunity creation date,
determining a subset of the one or more programs associated with one or more affirmative success flags as comprising one or more programs having a program date before the opportunity creation date of the each opportunity;
determining a count of the subset;
determining a pipeline generated per program metric based on a revenue value of the each opportunity divided by the count; and
storing the pipeline generated per program metric as a metadata tag for the subset of the one or more programs associated with one or more affirmative success flags in the marketing management system for the each opportunity.

18. The method of claim 10, wherein determining one or more metadata tags for the one or more programs associated with the at least one lead based on the retrieved plurality of interactions further comprises:
for each opportunity having an opportunity creation date, where each opportunity is open,
determining a subset of the one or more programs associated with one or more affirmative success flags as comprising one or more programs having a program date before the opportunity creation date of the each opportunity;
determining a count of the subset;
determining a pipeline open per program metric based on a revenue value of the each opportunity divided by the count; and
storing the pipeline open per program metric as a metadata tag for the subset of the one or more programs associated with one or more affirmative success flags in the marketing management system for the each opportunity.

19. The method of claim 18, wherein an open opportunity comprises an opportunity with no opportunity closing date.

20. A method for providing metadata-based cross-channel analytics in a marketing management system, the method comprising:
receiving a plurality of definitions of a plurality of marketing programs in a plurality of program channels of a plurality of different channel types for an account in a marketing management system;
determining a plurality of definitions of a plurality of metadata tags for the plurality of program channels of the plurality of different channel types, each metadata tag of the plurality of metadata tags measuring a success of a marketing program of a channel type of the plurality of different channel types;
receiving a request from a user of the marketing management system for one or more marketing programs attributable to an opportunity associated with the account;
determining one or more marketing programs attributable to the opportunity based on the plurality of metadata tags for the plurality of program channels; and
providing the one or more marketing programs attributable to the opportunity responsive to the request for display to the user of the marketing management system.

21. The method of claim 20, wherein a plurality of program channels of a plurality of different channel types for an account in a marketing management system comprises a program channel for a blog associated with the account.

22. The method of claim 20, wherein a plurality of program channels of a plurality of different channel types for an account in a marketing management system comprises a program channel for a call blitz associated with the account.

23. The method of claim 20, wherein a plurality of program channels of a plurality of different channel types for an account in a marketing management system comprises a program channel for a content syndication associated with the account.

24. The method of claim 20, wherein a plurality of program channels of a plurality of different channel types for an account in a marketing management system comprises a program channel for a direct mail campaign associated with the account.

25. The method of claim 20, wherein a plurality of program channels of a plurality of different channel types for an account in a marketing management system comprises a program channel for an email blast associated with the account.

26. The method of claim 20, wherein a plurality of program channels of a plurality of different channel types for an account in a marketing management system comprises a program channel for an email blast with a call to action associated with the account.

27. The method of claim 20, wherein a plurality of program channels of a plurality of different channel types for an account in a marketing management system comprises a program channel for a first touch direct mail campaign associated with the account.

28. The method of claim 20, wherein a plurality of program channels of a plurality of different channel types for an account in a marketing management system comprises a program channel for a listing of marketing qualified leads associated with the account.

29. The method of claim 20, wherein a plurality of program channels of a plurality of different channel types for an account in a marketing management system comprises a program channel for a micro-event associated with the account.

30. The method of claim 20, wherein a plurality of program channels of a plurality of different channel types for an account in a marketing management system comprises a program channel for online advertising associated with the account.

31. The method of claim 20, wherein a plurality of program channels of a plurality of different channel types for an account in a marketing management system comprises a program channel for a referral associated with the account.

32. The method of claim 20, wherein a plurality of program channels of a plurality of different channel types for an account in a marketing management system comprises a program channel for a roadshow associated with the account.

33. The method of claim 20, wherein a plurality of program channels of a plurality of different channel types for an account in a marketing management system comprises a program channel for a sponsorship associated with the account.

34. The method of claim 20, wherein a plurality of program channels of a plurality of different channel types for an account in a marketing management system comprises a program channel for a survey associated with the account.

35. The method of claim 20, wherein a plurality of program channels of a plurality of different channel types for an account in a marketing management system comprises a program channel for a tradeshow associated with the account.

36. The method of claim 20, wherein a plurality of program channels of a plurality of different channel types for an account in a marketing management system comprises a program channel for a user group meeting associated with the account.

37. The method of claim 20, wherein a plurality of program channels of a plurality of different channel types for an account in a marketing management system comprises a program channel for a virtual trade show associated with the account.

38. The method of claim 20, wherein a plurality of program channels of a plurality of different channel types for an account in a marketing management system comprises a program channel for a webinar associated with the account.

39. The method of claim 20, wherein a plurality of program channels of a plurality of different channel types for an account in a marketing management system comprises a program channel for a website associated with the account.

40. A computer program product comprising a computer-readable storage medium containing computer program code for executing instructions to perform a method of providing marketing analytics for different types of programs in a marketing management system, the method comprising:
receiving channel activity associated with an account on a marketing management system, the channel activity comprising a plurality of interactions by a plurality of leads with a plurality of programs provided on at least two program channels of different types, the plurality of leads interacting with the plurality of programs on a plurality of program dates;
retrieving a plurality of metadata definitions for the plurality of interactions with the plurality of programs received in the channel activity;
determining one or more metadata information items for the plurality of programs associated with the plurality of leads based on the retrieved plurality of metadata definitions;
determining one or more metrics for the plurality of programs associated with the plurality of leads and one or more opportunities associated with the account based on the determined one or more metadata information items;
storing the determined one or more metrics in the marketing management system; and
providing the determined one or more metrics for display to a viewing user of the marketing management system.

41. A computer program product comprising a computer-readable storage medium containing computer program code for executing instructions to perform a method for analyzing programs in different program channels in relation to opportunities in a marketing management system, the method comprising:
retrieving a plurality of interactions associated with at least one opportunity for an account in the marketing management system, where the at least one opportunity is associated with at least one lead associated with the account;
determining one or more programs associated with the at least one lead;
determining one or more metadata tags for the one or more programs associated with the at least one lead based on the retrieved plurality of interactions;
determining a success flag for each of the one or more programs associated with the at least one lead, each success flag determined based on the retrieved plurality of interactions associated with the at least one opportunity; and
storing the one or more success flags for the one or more programs associated with the at least one lead in the marketing management system.

42. A computer program product comprising a computer-readable storage medium containing computer program code for executing instructions to perform a method for providing metadata-based cross-channel analytics in a marketing management system, the method comprising:
receiving a plurality of definitions of a plurality of marketing programs in a plurality of program channels of a plurality of different channel types for an account in a marketing management system;
determining a plurality of definitions of a plurality of metadata tags for the plurality of program channels of the plurality of different channel types, each metadata tag of the plurality of metadata tags measuring a success of a marketing program of a channel type of the plurality of different channel types;
receiving a request from a user of the marketing management system for one or more marketing programs attributable to an opportunity associated with the account;
determining one or more marketing programs attributable to the opportunity based on the plurality of metadata tags for the plurality of program channels; and
providing the one or more marketing programs attributable to the opportunity responsive to the request for display to the user of the marketing management system.
